(19) United States
(12) Patent Application Publication
(10) Pub. No.: US 2016/0070636 A1
(43) Pub. Date: Mar. 10, 2016

(54) CONDITIONAL WRAPPER FOR PROGRAM OBJECT

(71) Applicant: Home Box Office, Inc., New York, NY (US)

(72) Inventors: Tyler R. Furtwangler, Sammamish, WA (US); Brandon C. Furtwangler, Issaquah, WA (US); Nathan J. E. Furtwangler, Kirkland, WA (US)

(21) Appl. No.: 14/843,908

(22) Filed: Sep. 2, 2015

Related U.S. Application Data
(60) Provisional application No. 62/046,128, filed on Sep. 4, 2014.

(51) Int. Cl. G06F 11/36

(52) U.S. Cl. CPC G06F 11/3612; G06F 11/3636

(57) ABSTRACT

The described technology is directed towards conditional wrapper that wraps part(s) of a selected program object with added logic, such as to perform validation and/or tracing on part(s) the object; the wrapper may be multi-functional in this regard. The wrapper logic is selectively added to one or more selected object parts by the object creator at object creation time based upon conditional data. During runtime, the added logic may be run before the wrapped part of the object (e.g., a function) is executed and/or after execution of the object part. Validation and/or tracing operations may be run before the part of the object is executed as well as after the part of the object is executed. Objects that do not meet the conditional data criteria are created and returned without any added wrapping logic.

### CROSS-REFERENCE TO RELATED APPLICATION

The present application claims priority to U.S. provisional patent application Ser. No. 62/046,128, filed Sep. 4, 2014, the entirety of which is incorporated herein by reference.

### BACKGROUND

Developing a computer program is often a very large and cumbersome task. For any relatively large project, there is a significant amount of coding that needs to be done, followed by testing and debugging. This typically leads to frequent changes, new enhancements and so forth, which may fix many errors but also may introduce new errors.

For example, consider a program written in JavaScript® or similar loosely-typed programming language. Programming languages that are loosely typed have variables that are declared without a type; the programming language determines the type for each declared variable and there is no internal type checking performed. Further, types are dynamic, e.g., a variable x may be set to a numerical value (var x=10, whereby variable x's type is a number) and later, possibly in the very next statement, the same variable x may be set to a string (var x=“Tuesday”, whereby variable x's type is now a string). These characteristics of JavaScript® can lead to a number of errors. For example, an existing function may expect a string as a parameter when invoked by a new calling function, but that new calling function may instead provide a number, causing a bug.

Code written in dynamic languages, such as JavaScript® code, can be harder to maintain and debug due to its dynamic runtime behavior. Function parameters, return values, and property accessors are not type-enforced, resulting in a large amount of code that needs to handle any object type at any time. It is common for JavaScript® code to have a large amount of checks inside of a function to ensure that the parameters are of the correct type and/or shape. Additionally, the results of functions are typically checked before using them due to this same dynamic nature. To make these checks, robust JavaScript® code nearly always litters ‘if’ checks to validate the incoming and outgoing data. Without the checks, it is easy to misuse the code and do unexpected things (something may not fail right away, leading to subsequent issues). These checks clutter the code and negatively impact performance. Tracing is another testing/debugging tactic that negatively impacts performance; globally tracing a program also logs a considerable amount of data, much of which is not needed when looking for a problem.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, the technology described herein is directed towards a conditional wrapper, coupled to an object creator, that wraps a part of an object (e.g., a function) with added logic. The conditional wrapper is selectively added to the object by the object creator at object creation time based upon conditional data. During runtime, some added logic may be run before the part of the object is executed and/or some after the part of the object is executed. The added logic may perform validation and/or tracing, which may include running validation and/or tracing operations before the part of the object is executed as well as after the part of the object is executed.

Other advantages may become apparent from the following detailed description when taken in conjunction with the drawings.

### BRIEF DESCRIPTION OF THE DRAWINGS

The technology described herein is illustrated by way of example and not limited in the accompanying figures in which like reference numerals indicate similar elements and in which:

FIG. 1 is a block diagram representing example components that may be used to provide conditional wrappers for selected program objects, according to one or more example implementations.

FIG. 2 is a flow diagram showing example steps that may be taken to wrap an object with validation wrapper logic and/or trace wrapper logic, or return an unwrapped object implementation, according to one or more example implementations.

FIG. 3 is a block diagram representing example concepts of a validation wrapper, according to one or more example implementations.

FIG. 4 is a block/dataflow diagram representing various aspects related to using a validation wrapper during runtime of a wrapped function, according to one or more example implementations.

FIG. 5 is a flow diagram showing example steps that may be taken to validate a function via validation wrapping logic, according to one or more example implementations.

FIG. 6 is a block diagram representing example concepts of a trace wrapper, according to one or more example implementations.

FIG. 7 is a block/dataflow diagram representing various aspects related to using a trace wrapper during runtime of a wrapped function, according to one or more example implementations.

FIG. 8 is a flow diagram showing example steps that may be taken to trace data and/or a function via trace wrapping logic, according to one or more example implementations.

FIG. 9 is an example block diagram of a system that may implement a conditional wrapper pattern, according to one or more example implementations.

FIG. 10 is a block diagram representing an example computing environment into which aspects of the subject matter described herein may be incorporated.

### DETAILED DESCRIPTION

Various aspects of the technology described herein are generally directed towards a conditional object wrapper that wraps a part of an object (e.g., the object itself (e.g., its name and type information), a function therein, an event and so on) with code that triggers an evaluation-related action with respect to the wrapped part of the object, when executed during runtime. For example, the conditional wrapper may comprise a validation wrapper that causes data related to a function, including input parameter(s) and/or output return value(s), to be validated during runtime, thereby catching any error caused by improper data. As another example, the conditional wrapper may comprise a tracing wrapper that causes trace points to be recorded (e.g., logged) before, during and/or after a part of the object is executed during runtime.

The conditional wrapper may be selectively applied to only certain objects or certain parts of objects, e.g., at object creation time, based upon condition data. For example, although the conditional wrapping may be applied globally to a program's objects as a whole, the condition data may specify that the conditional wrapper only be applied to objects in a certain area of the program, e.g., one that is directed towards a subtask. The conditional wrapper may be added to parts of an object, e.g., the object's information, one or more functions, properties, events, and so on; (note that not only may typical types of functions be wrapped, but properties have getter and setter functions that can be wrapped for validation and/or tracing evaluation like other methods).

In one or more implementations, a wrapper pattern corresponds to a central place (e.g., a system that creates JavaScript® objects from class-type definitions) that creates a program's objects. For example, the wrapper pattern may wrap a function call in a way that emits a new function that contains additional logic, yet remains able to call through to the original function. This wrapper pattern thus allows for functions to be selectively/conditionally wrapped, such as for running a debug build of a program (validate and/or trace code while running) versus a production build (no validation or tracing). The wrapper pattern may be applied to an area of a program such as based upon a namespace/class name, to a method/property name (a private variable notation), and so on. Some of such information may be maintained in a separate file or other data structure associated with the object. For example, a tester may specify that all functions within an area of a program that perform some program task (e.g., handles network communication) be validated; the validation function/statements to use are identified in each function's document file(s), but the tester need only provide such information to the OOP system once (e.g., identify an object namespace that identifies the objects that handle network communication) in order to turn on validation for those functions.

When an object part is wrapped, the additional logic causes validation, tracing, and/or can trigger virtually any other thing that a developer/tester/debugger may consider helpful. For example, the additional logic may pause the program and notify the developer/tester. When not wrapped the original function is created and without modification, allowing maximum performance when used during runtime. By utilizing the wrapper pattern in the creation of an object and its parts (e.g., functions, properties, and extended syntax/framework-specific functionality of a language), there is a central point for extended validation and tracing throughout the application program in a uniform way.

With respect to validation, type definitions may use the wrapper pattern for selected properties, methods, and so forth. The wrapper pattern decides whether to use the wrapped implementation version or the original implementation based on virtually any condition data specified by a developer/tester. For example, specific conditions may be evaluated when deciding whether to wrap, including having a developer or test file specify which functions and/or properties are to be validated and/or traced, which area of a program to validate, which objects are mocked during testing (whereby validation or tracing of mocked objects is generally unneeded) and so forth. External conditions may be considered, e.g., enable validation for a function that sometimes fails during low memory conditions, or when there is a slow network connection, and so on, to help debug that function.

With respect to validation, validation can be extended beyond variable type checking and used to ensure that input data/output data are otherwise valid. An example is to check that an input data/output data value is within a certain range (e.g., between 0 and 100), is valid with respect to an enumeration (e.g., is a value identified within an enumeration of HTTP status codes) and so on. Another example is a validation of types that checks whether inputs/outputs are created from a specific system (e.g., one that processes class definitions into JavaScript® objects) and that the instance has a specific namespace/name (or derived type) in that system. Additionally, there may be a validation that enforces that an instance implements a specific interface. As is understood, the conditional wrapper may be used to validate virtually anything that can be checked.

Once validation is successfully performed on a program, validation need not be used on that program, with the resulting code being much cleaner, as it does not need validation checks therein cluttering the code. Moreover, the validation that is done on the input data and output data is more consistent than performing checks in traditional code. To facilitate consistency, in one or more implementations the validation of an object part comes from documentation (e.g., a JavaScript® Object Notation (JSON) object that describes the object), such that validation functions and/or validation-related statements are automatically picked up during the wrapping operation. With validation via documentation, it is more difficult to misuse JavaScript® code and get unexpected results from API calls.

With respect to tracing, many languages do not provide a good tracing mechanism, which makes debugging more difficult on certain platforms (such as devices without an easy remote debugging solution). Enabling tracing across the board is expensive, as every function call has some negative performance impact associated with tracing, and a great deal of data is generated.

By using the wrapper pattern, there is a central place to determine if and when to trace function calls based upon condition data. A wrapped function can trace information associated with the function call before calling the original function implementation, and again trace information after calling it. This provides trace points that can be used for debugging behavior of an application program, and timing information to provide more context on code performance.

Because of the overhead associated with tracing information, the wrapping functionality can decide if and when to perform tracing, e.g., whenever a method is called or a property's value changes, for example. As with validation, condition criteria may be used to selectively enable the tracing, such as which area of code a function came from. In one or more implementations, a logging configuration file (e.g., part of the condition data) may be accessed to determine whether the object creator needs to generate the additional tracing code for each method or property.

Consider for example a developer trying to find a problem associated with input from a keyboard in an application program. The tracing is selectively enabled for the input-related classes, but disabled for others. This allows a smaller amount of trace information to be processed (and sent remotely if needed), which does not impact performance as much as enabling tracing globally.

With respect to properties, determining when and where properties are set can be a tedious task, yet doing so is often significant when finding issues. By enabling tracing on a specific property setter, it is far less difficult to see when and where a property was set. This is similarly true for a property getter.

It should be understood that any of the examples herein are non-limiting. For instance, many of the examples refer to validating a function's (method's) input parameter(s) and output result(s) during validation, and/or validating a property's values, as well as tracing functions and property setters. However, virtually any describable entity in the code may be validated, including but not limited to functions, property getters, property setters, property values, interfaces, events, input and output values, input and output value types, data shape (e.g., format) and so on. Moreover, any code that executes may be traced. As such, the technology described herein is not limited to any particular embodiments, aspects, concepts, structures, functionalities or examples described herein. Rather, any of the embodiments, aspects, concepts, structures, functionalities or examples described herein are non-limiting, and the technology may be used various ways that provide benefits and advantages in computing and programming in general.

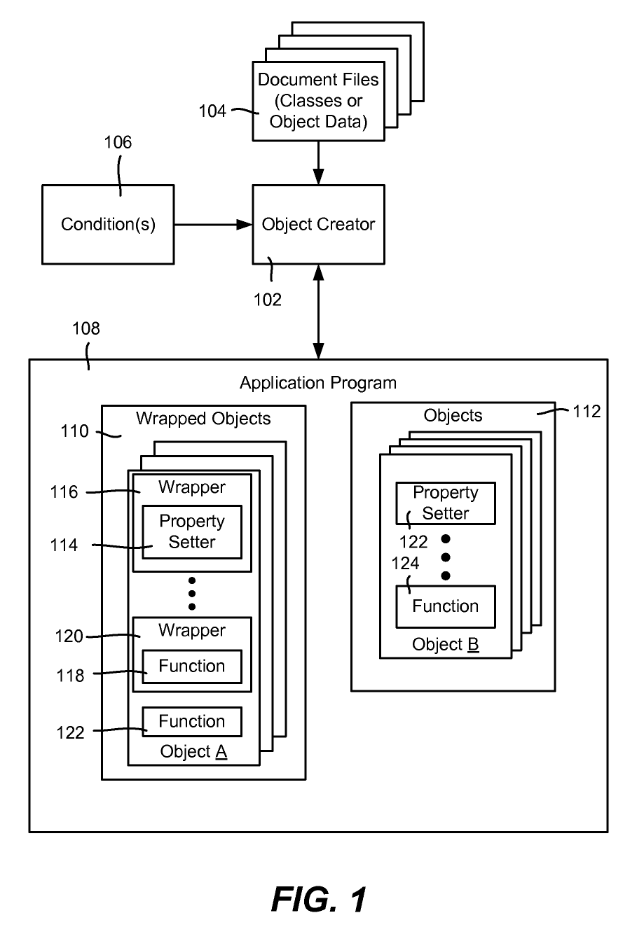

FIG. 1 is a block diagram showing an object creator 102 that creates objects based on document files 104, representing classes, subclasses and so on. As described herein, based upon one or more condition data 106 (e.g., set by a developer or test code), various part(s) of any object of an application program 108 may be wrapped with validation-related code and/or tracing-related code (and/or possibly other code related to object evaluation); these are shown in FIG. 1 as wrapped objects 110. For objects in which the condition data is not met, the objects 112 are created for the application program in their original (unwrapped) form.

As shown in FIG. 1, any part of an object may be wrapped. An object may be wrapped with validation code that validates that the object is part of a certain framework/type system, and validation code for other parts. An object may be wrapped with code related to tracing. For example, object A of the represented wrapped objects 110 includes a property setting 114 that is wrapped with a wrapper 116 and a function 118 that is wrapped with a wrapper 120. Note that it is feasible to have an object part wrapped with both a validation wrapper and a tracing wrapper; typically if both are used, validation is outside the tracing wrapper so that the tracing does not trace the validation-related operations, (unless tracing the validation-related operations in addition to the object part was desired).

As shown in FIG. 1, wrapping is not necessarily performed on every part of a wrapped object; e.g., the function 122 of object A is not wrapped. In general, the developer/test code can selectively turn on wrapping for any object part or set of object parts, (e.g., to wrap all functions in the area of the program that deals with HTTP communications).

As also shown in FIG. 1, only selected ones of the objects may be wrapped. Other objects 112 have no wrapping at all, e.g., the property setter 122 and the function 124 of the object B are shown as is, without wrapping, and in the example of FIG. 1, no other parts of the object B or any of the objects 112 are wrapped. Such unwrapped objects are thus run as normal, without the overhead that results from executing the wrapping code and its related operations of validation and/or tracing, for example.

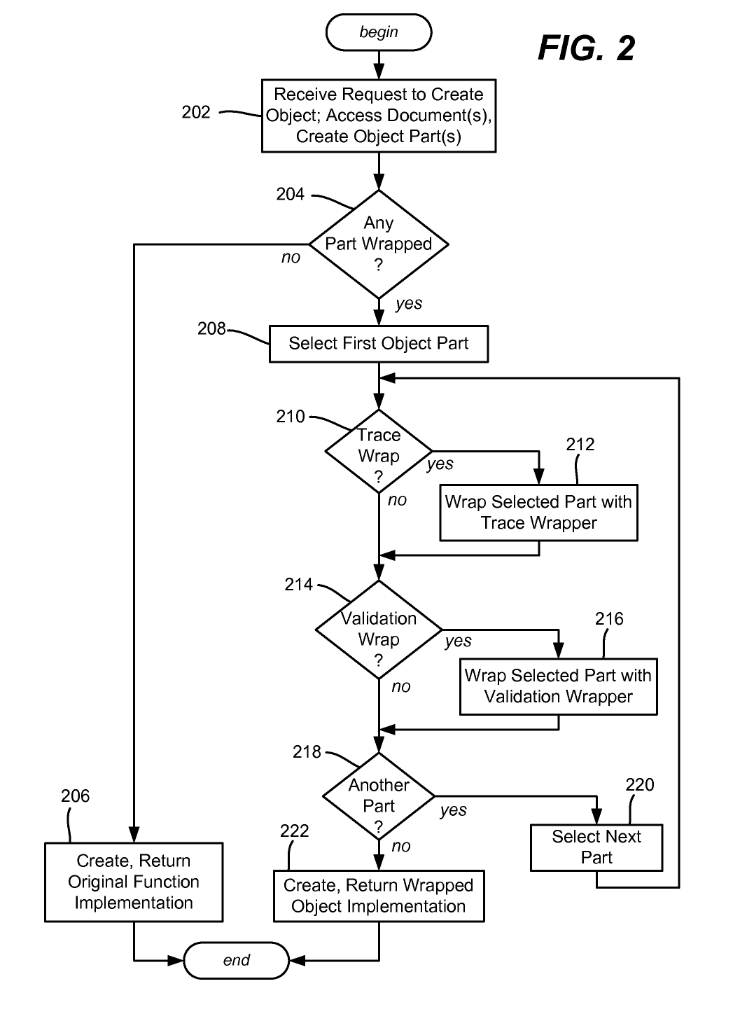

FIG. 2 shows logic in the form of example flow diagram steps that may be used during object creation to determine wrapping or not for an object being created, beginning at step 202 where a request to create the object is received and the document or document(s) describing that object are accessed to create the object and its various part(s), e.g., properties, functions, events and so on. Note that each class or the like used to create the object typically has its own document, however an object may derive from another object/class, and thus more than one document may be needed to determine validation and/or tracing related information for the object.

Step 204 represents evaluating one or more conditions as exemplified herein that determine whether any part of the object is to be wrapped. If not, step 204 branches to step 206 wherein the object is returned in its original form (without wrapping) to the requesting entity, e.g., the application program at launch time or during runtime.

If at least some part of the object is to be wrapped, including the object's general information (e.g., to validate that it properly belongs to a type system based upon its fully qualified name, which is identified in a part of the object and is registered with the type system), step 208 selects the first object part. Step 210 evaluates whether the condition data indicates that this part is to be wrapped with trace wrapping code. If so, step 212 wraps the part with trace wrapping code.

Step 214 evaluates whether the condition data indicates that this selected part is to be wrapped with validation wrapping code. If so, step 216 wraps the part with validation wrapping code. Note that if both wrappers are used, validation is generally not part of tracing, e.g., pre-validation operations (before running a traced entity) and post-validation operations (after running the traced entity) are themselves not traced, unless this is desired, in which event it is straightforward to do so.

Steps 218 and 220 repeat the wrapping operations for each part of the object. In this way, any property, method, event, constructor and so on may be wrapped. When the object is wrapped as specified by the condition data, step 222 returns the wrapped object to the requesting entity. It should be noted that steps 204 and 206 are optional for efficiency, in that an object that is not wrapped will never have step 212 and/or 216 performed for any part thereof, and in this situation step 222 will instead return an unwrapped object. However, if the object creator knows that object wrapping is not specified for the object, there is no need to traverse each part separately.

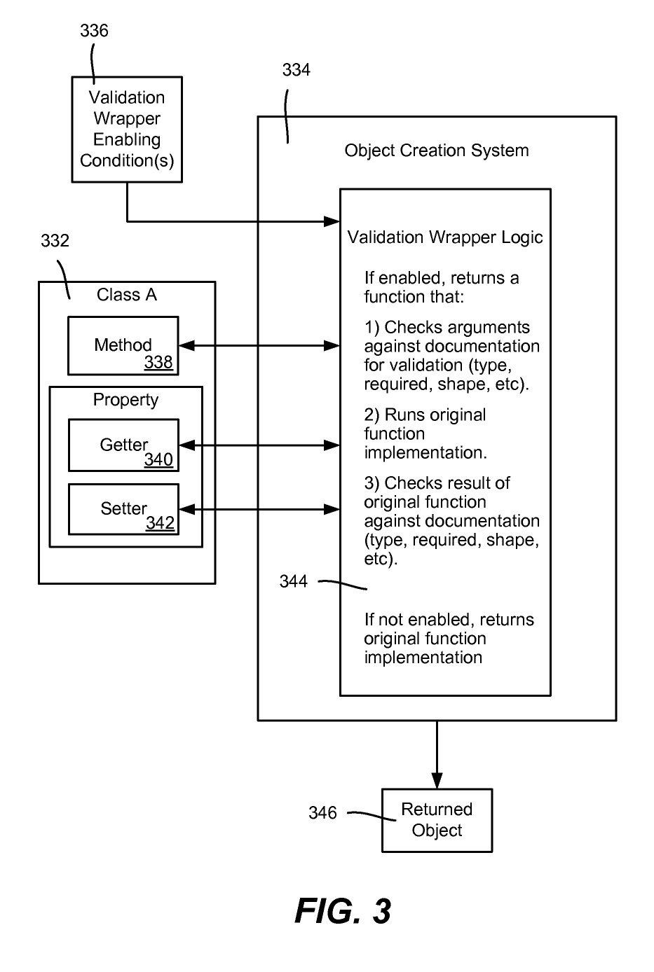

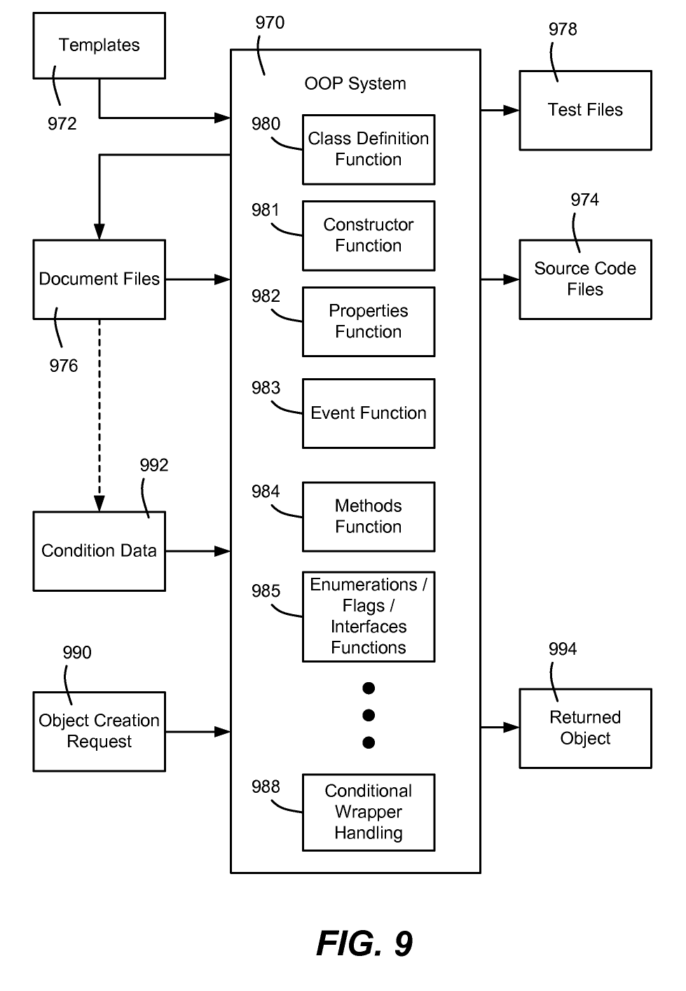

FIG. 3 exemplifies validation wrapping, and shows an example class A 332 that is to be converted to an object (e.g., a JavaScript® object), e.g., by an object creation system 334 at object creation time. Although JavaScript® is prototypal and does not have classes, an OOP system, described herein with reference to FIG. 9, may perform such an operation. As before, whether to wrap a given object or any part thereof with a validation wrapper depends on validation wrapper enabling condition data 336.

In the example of FIG. 3, any method 338 or property getter 340 or setter 342 may be selectively wrapped with a validation wrapper 344. Events, property data, constructors and so on likewise may be wrapped. If enabled for a function such as the method 338, for example, the validation wrapper logic 344 returns a modified function that 1) checks arguments against documentation for validation (type, required, shape, etc), 2) runs the original function implementation and 3) checks the result of the original function against documentation (type, required, shape, etc). Similar validation operations may be done with the exemplified property setter and getter 340 and 342, (as well as for other object entities such as events). If not enabled, the validation wrapper logic 344 does not modify the original object implementation.

The returned object 346 is thus the original implementation or wrapped in some way with validation code. Note that FIG. 3 is with respect to validation wrapping only; the returned object 346 may not have validation wrapping but may be wrapped with trace wrapping, as described herein.

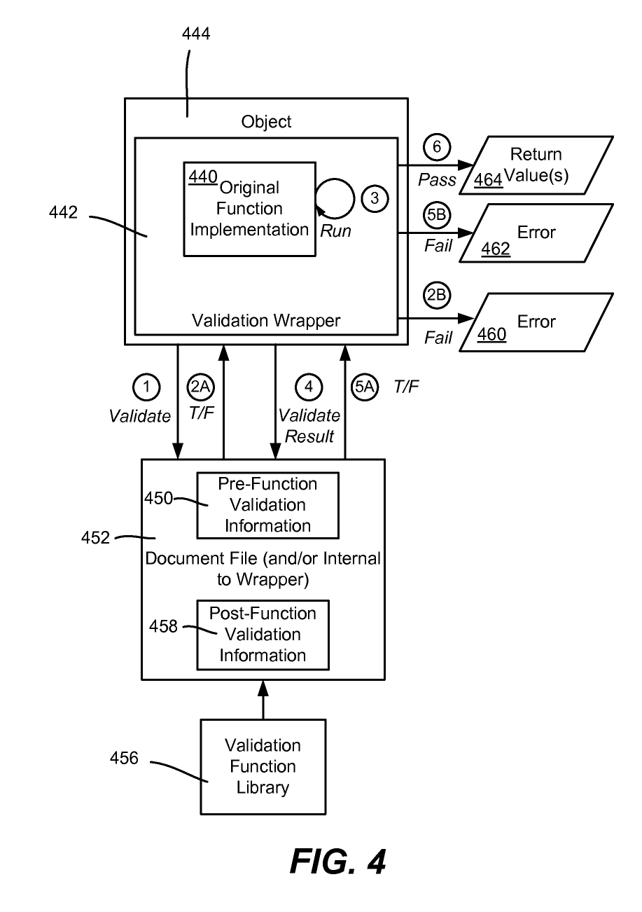

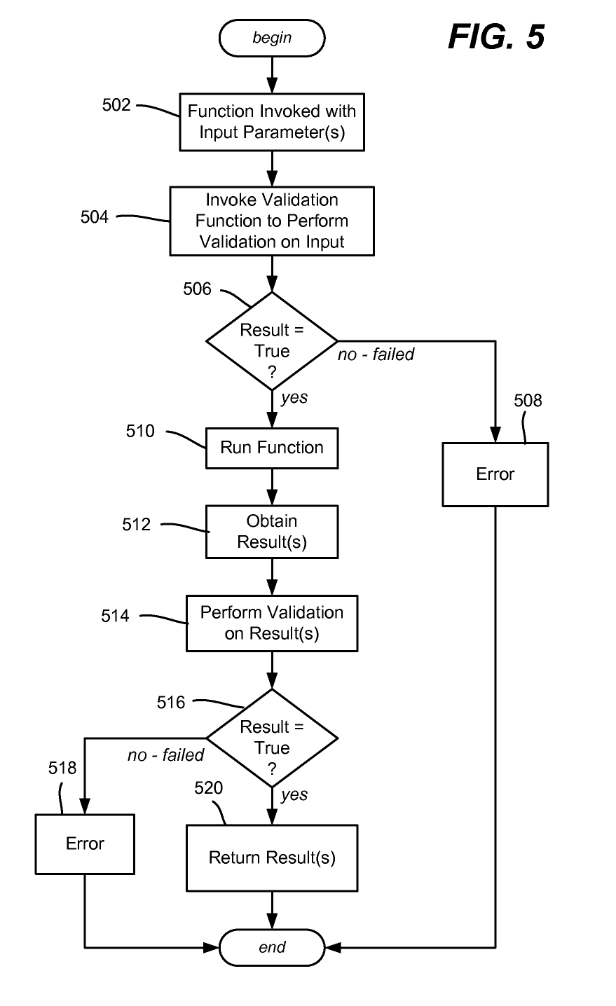

FIGS. 4 and 5 show how validation generally operates during runtime, using the example of a function 440 wrapped with a validation wrapper 442 as part of an object 444. For any function, there are typically two phases of validation, namely pre-validation that checks the input parameter(s) as adhering to the function's input requirements, and post-validation that checks the returned value(s) as meeting the function's output requirements. Note that the function (ordinarily) is not allowed to run unless pre-validation passes; (although it is feasible to allow a function to proceed, such as to test how a function handles bad input).

Thus, when a wrapped function 440 (FIG. 4) is invoked with one or more input parameters (step 502 of FIG. 5), validation of the input is performed, as represented by the arrow labeled (1) in FIG. 4. In one or more implementations, this involves accessing (directly or indirectly) pre-validation information 450 in a document file (JSON object) 452 associated with the wrapped object 444 that indicates how the function is to be validated. The pre-validation information 450 and post-validation information 458 (e.g., validation functions, statements and or data values for comparison) may be directly copied into the validation wrapper 442 logic at object creation time, that is, blocks 450 and 458 of FIG. 4 may be contained within block 442, or the validation wrapper logic (or the object creator) knows how to access this information when needed. As can be appreciated, any entity may be arranged to participate at any level, so for example the validation wrapper code may ask for validation to be performed externally and get back a result, or may participate in internal validation at least to some extent in running/invoking the validation code).

In any event, the pre-validation information 450, may specify, for example, that a validation function or set of validation functions be invoked (as represented by step 504 of FIG. 5). The function may be provided via a validation function library 456. Instead of or in addition to a validation function or set of validation functions, the pre-validation information 450 alternatively may include a set of statements that are executed to perform validation. For example, the pre-validation information 450 may include a statement that passes validation if the result of some validation function A AND-ed with the result of some validation function B is True.

In this example, the validation is performed (internal or external to the validation wrapper 442, or some combination of both internal and external) with a True (Pass) or False (fail) status resulting (arrow (2A)). In the situation where pre-validation fails, an error 460 is output (arrow (2B) in FIG. 4). This is also represented in the example flow diagram of FIG. 5 via steps 506 and 508.

In the situation where the pre-validation passes, the original function is run by the wrapper (arrow (3) in FIG. 4, step 510 in FIG. 5). At step 512 of FIG. 5, the function's return value(s)/results are obtained. Post-validation, which also may be an invoked validation function, set of validation functions and/or validation statements) then checks the result of the function at steps 514 and 516. This is also shown in FIG. 4 via (arrows (4) and (5A)).

In the situation where post-validation fails, an error 462 is output (arrow (5B) in FIG. 4). This is also represented in the example flow diagram of FIG. 5 via steps 516 and 518.

In the situation where the pre-validation passes, the returned value(s)/result(s) of the function are returned. This is represented by arrow (6) in FIG. 4 and in the example flow diagram of FIG. 5 via steps 516 and 520.

By way of example of a validation check, a variable value may be checked for being the correct type and as having a correct value. For example, an input parameter that needs to be a valid HTTP status code may be checked during pre-validation for being of type number and as having a value that matches an enumeration comprising the set of valid HTTP status codes. A return value may need to be a number between 0 and 100; type checking for a number along with having a value that falls within the specified range is thus performed during post validation. As can be readily appreciated, other object parts such as property setters and getters, events, constructors and so forth may be similarly type checked, value checked and so forth for validation, (although the concept of pre-validation and post-validation may not apply, such as if checking to see whether a property value is a string before any part of the object executes).

It should be noted that the validation system described herein allows for complex validations, e.g., using Boolean operators such as AND and OR. For example, one function may perform type checking, with its result AND-ed with another function's result that determines whether a value matches an enumeration (or falls within a range and so on—basically anything a developer specifies); only if both are True is the True result returned in this example. A property setter may, for example, set a property as a number value OR a string value (but not, for example, a Boolean type, null type, undefined type or symbol type); validation thus may check that the value to be set is a number value OR a string value, with True returned if any one (or both) is True.

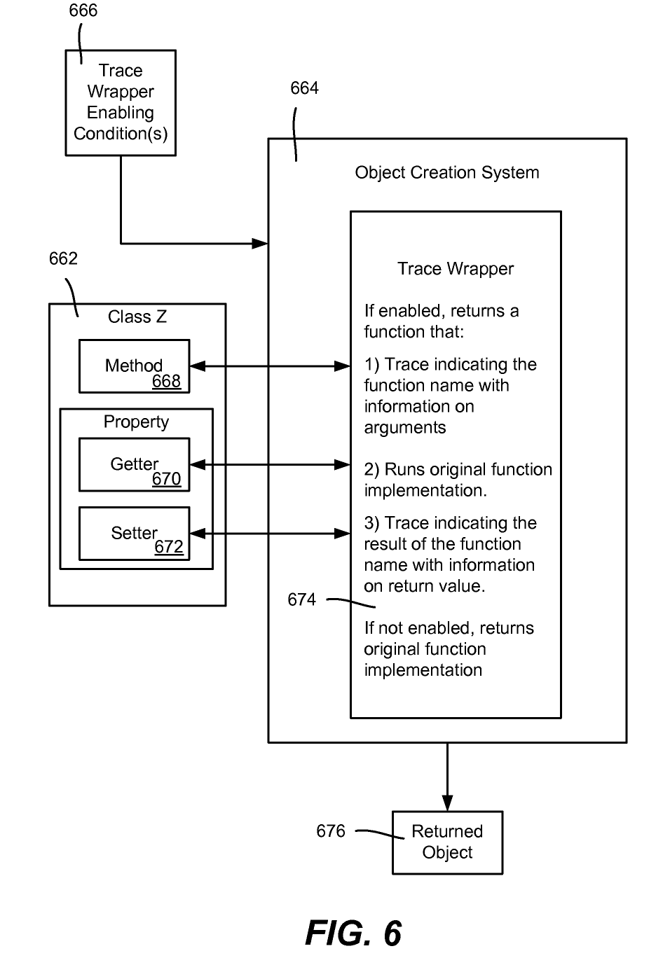

FIG. 6 exemplifies trace wrapping, and shows an example class Z 662 that is to be converted to an object (e.g., a JavaScript® object), e.g., by an object creation system 664 at object creation time. As before, whether to wrap a given object or any part thereof with a validation wrapper depends on validation wrapper enabling condition data 666.

In the example of FIG. 6, any method 668 or property (getter 670 or setter 642) may be selectively wrapped with a trace wrapper 674. Events, constructors and so on likewise may be wrapped. If enabled for a function such as the method 668, for example, the trace wrapper 674 returns a modified function that 1) starts a trace and/or records trace data indicating the function name with information on arguments, 2) runs the original function implementation, and 3) stops the trace and/or records trace data after indicating the result of the function name with information on the return value(s). Similar tracing operations may be done with the exemplified property setter and getter 670 and 672, (as well as for other object entities such as events). If not enabled, the trace wrapper 674 does not modify the original object implementation (although it may be validation wrapped and not actually wind up as the original; for brevity, validation is not used in this example). In the example of FIG. 6, the returned object 676 is thus the original implementation or wrapped in some way with trace-related code.

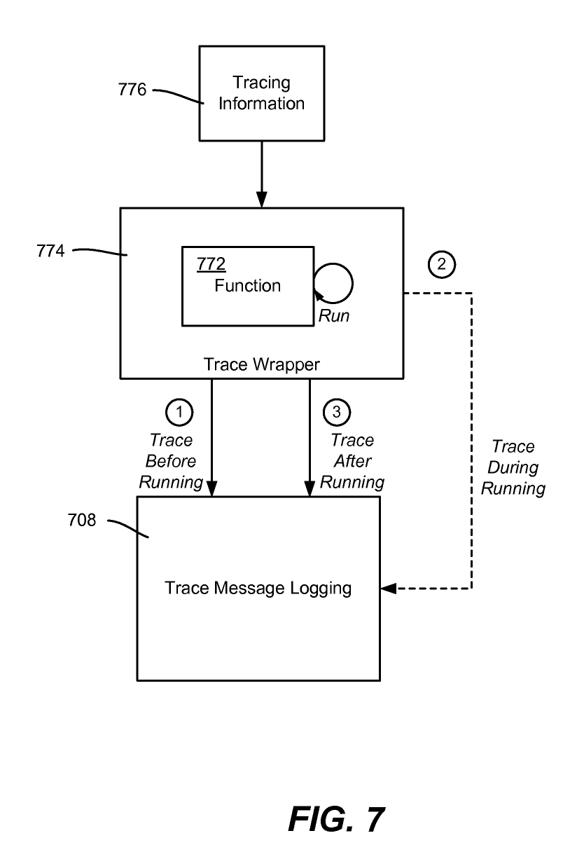

FIG. 7 is an example block diagram directed towards aspects of tracing, using an example of a function 772 as the object part to be traced. In FIG. 7, the function 772 is wrapped with a trace wrapper 774, which may access tracing information 776 (if available, such as in the object's associated documentation) to obtain any variable information indicating trace constraints/considerations; e.g., which type of messages to log, and which to filter out, whether to only record before and after trace points or also trace the code execution.

Depending on the purpose of the tracing, tracing may not be turned on during code execution. For example, to evaluate performance of a function, it may be deemed more accurate to log the start time of a function and possibly the state of some data (e.g., the input parameter values) before running the function, and log the end time of the function and possibly the state of some data (e.g., the function's return values); there may not be any tracing done while running the function, as tracing would give false performance data. Alternatively, start time/start data may be saved as a start trace point, with tracing turned on during function execution to capture various trace messages, along with saving the end time/end data as an end trace point. How to perform tracing may be maintained in the tracing information 776 for an object, e.g., in the object's associated document file(s). There may not be any variable information other than to trace a function or the like, in which event by default the start of tracing is logged with start-related data, tracing is turned on (or alternatively not turned on by default), the function run, tracing turned off, and the end of tracing logged with end-related data.

As shown in FIG. 7, via the trace wrapper 774 (logic) the wrapped function 772 can trace information associated with the function call in a log 708 or the like before invoking the original function implementation (arrow (1)), and after invoking the original function (arrow (3)). Trace information may be gathered during function execution (arrow (2)). The wrapper 774 thus provides trace points that can be used for debugging the behavior of any part of an application, and timing information to give some context on how performant code is. The wrapper 774 is also able to turn tracing on and off with respect to tracing the function execution. In any event, conditional tracing as described herein limits the amount of data that results from tracing, e.g., to only the trace point data logged before and after running the function, or to the trace point data logged before and after running the function, along with the trace-related data captured while running the function (but not captured for the entire code execution).

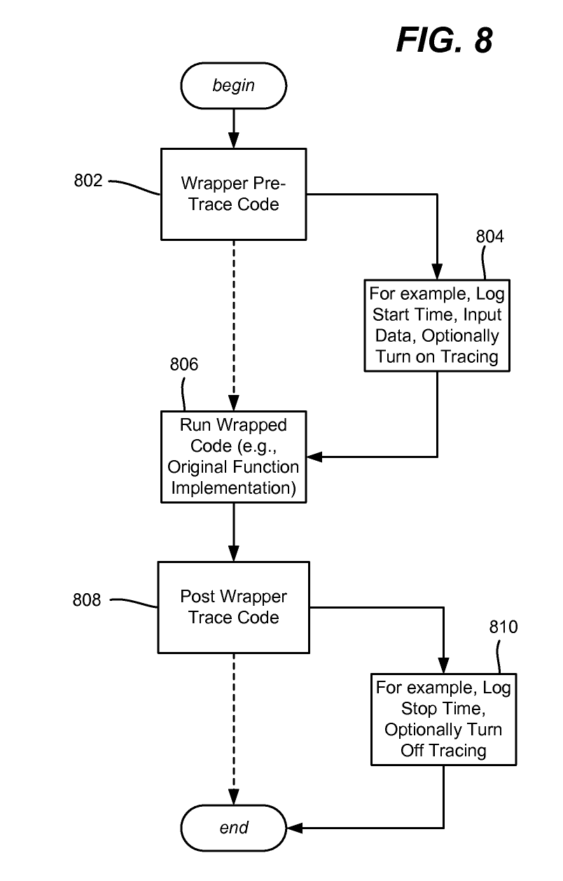

FIG. 8 shows a flow diagram with example steps related to tracing, beginning at step 802 where wrapper pre-trace code is executed. This may, for example, include the operations represented by block 804, to log the start time and input data, and optionally to turn tracing on so as to trace the function's execution.

Step 806 runs the original function implementation that is wrapped with the wrapping code. (It is also feasible to run a function wrapped with validation wrapping code, however this is not done in the example of FIG. 8.)

Step 808 executes the wrapper post-trace code. This may, for example, include the operations represented by block 810, e.g., to log the end time and the function's output data, and optionally to turn tracing off (if turned on) so as to limit the tracing messages to only those resulting from the wrapper and logged based upon the function's execution.

Turning to another aspect, projects that have their own frameworks for simplifying class/type creation can simplify their validation code by allowing the conditional wrapper to do this for them, as well as selectively apply tracing. By combining the wrapper pattern with other framework-specific elements, a rich validation and tracing solution is achieved.

For example, in FIG. 9 an OOP type system 970 has a set of framework-specific type information that can be used by the wrapper pattern. In general, the OOP system 970 takes in templates 972 (e.g., corresponding to class definitions) and produces source code files 974, document files 976 (e.g., JSON objects) and test files 978. These files are maintained in a document system or the like. Documentation that is more “human-readable” may likewise be generated.

To produce the various output, the OOP system 970 includes various functions, including a class definition function 980, constructor function 981, properties function 982, event function 983, methods function 984 and other functions, e.g., functions 985 that support other object-oriented features such as enumerations, flags, interfaces and so on. Conditional wrapper handling code 988 for adding conditional wrapper logic to the object as described herein is also provided.

During a launch time and/or runtime for development/testing/debugging (e.g., not the production build runtime where the objects are established for each production version of the program), when an object creation request 990 comes in as described herein, condition data 992 is used to determine whether to add conditional wrapper logic 994 to the object. As also described herein, at least part of the condition data 992 may be specified in the document file or files 976 associated with the object being requested, as well as the validation and tracing-related data, e.g., which validation functions to perform, how to trace and so on. Alternatively such information may be maintained in a separate file or other data structure associated with the object.

In general, in creating the object, the OOP system 970/conditional wrapper handling code 988 uses the condition data 992 to decide whether or not to wrap the object, and if wrapping is determined, how to wrap the object. The requested object is thus returned as the returned object 996, whether wrapped or unwrapped as described herein.

Note that validation may include validation on OOP types and instances (derived types, interfaces implemented by that instance, etc) and OOP events with validation on the arguments when the event fires. An OOP enumeration type ensures the provided value is a valid enumeration value. Validation applied to functions and properties have been exemplified herein as well.

As can be seen, there is described a technology in which a wrapper pattern wraps selected object part(s) based upon condition data, such as object functions, at object creation time. When wrapped, the additional logic can add validation, tracing, (and other logic that may be helpful) that is executed during runtime. For objects that are not wrapped, the original object function is used without modification during runtime.

One or more aspects are directed towards determining whether to wrap an object part with wrapping code related to adding logic to the object part for execution of the logic during runtime, including making a determination as to whether to wrap based upon wrapping condition data. If the determination is to wrap, described herein is wrapping the object part with wrapping code to return a wrapped object implementation. If the determination is to not wrap, an unwrapped object implementation is returned

The wrapping condition data may indicate that the object part is to be validated during runtime, whereby the determination is to wrap. Wrapping the object part with the wrapping code may include wrapping the object code with validation wrapping code comprising validation-related logic. When the object part is a function, the validation-related logic may include pre-validation logic that executes before invoking the function and post validation logic that executes after invoking the function. For example, running the pre-validation wrapping code may validate one or more input parameters and running the post-validation code may validate one or more return values of the function. Running the pre-validation wrapping code results in invoking at least one validation function.

When the wrapping condition data indicates that the object part is to have trace data maintained for the object part when the object part is executed during runtime, the determination is to wrap. Wrapping the object part with the wrapping code may include wrapping the object code with trace wrapping code. The wrapping code may include starting tracing of the execution of the object part, executing the object part, and stopping tracing. The wrapping code may be directed towards logging trace information representing a start trace point related to the object part and logging other trace information representing a stop trace point related to the object part. Logging the information representing the start trace point may include logging a starting time and logging start-related data, and logging the information representing a stop trace point may include logging a stopping time and logging stop-related data.

The object part may be a function, logging the trace information representing the start trace point related to the function may include logging input parameter data to the function, and logging the trace information representing a stop trace point related to the object part may include logging one or more return values of the function.

Wrapping condition data may indicate that the object part is to be validated and traced during runtime, whereby the determination is to wrap. Wrapping the object part with the wrapping code may include wrapping the object code with tracing wrapping logic and wrapping the object code with validation wrapping logic.

One or more aspects are directed towards an object creator that creates an object and a conditional wrapper, coupled to the object creator, that wraps a part of the object with added logic. The conditional wrapper is selectively added to the object by the object creator at object creation time based upon conditional data. The conditional wrapper is configured to run the added logic before the part of the object is executed during runtime and/or after the part of the object is executed during runtime.

The added logic may be configured to trigger a validation of data to be used by the part of the object before the part of the object is executed, and/or may be configured to trigger a validation of data returned by the part of the object after the part of the object is executed.

The added logic may be configured to trigger a saving of trace-related data with respect to the part of the object before the part of the object is executed and after the part of the object is executed. The added logic may be configured to trigger a saving of trace-related data generated during execution of the part of the object.

The added logic may be configured to trigger a validation of data corresponding to the part of the object and to trigger a saving of trace-related data corresponding to the part of the object.

One or more aspects are directed towards wrapping a function with pre-validation code and post-validation code, in which the function is selected for wrapping based upon condition data associated with the function at object creation time. During runtime, the pre-validation code is run to determine whether to run the function. If running the pre-validation code determines that the function is not to run, an error is output. If running the pre-validation code determines that the function is to run, described herein is running the function, and running post-validation code to determine whether to return a result of the function. If running the post-validation code determines that the result of the function is not to be returned, an error is output; if running the post-validation code determines that the result of the function is to be returned, the result of the function is returned.

The function may be wrapped with trace code based upon the condition data. Wrapping the function with trace code may include adding logic that saves start trace point data before running the function and that saves stop trace point data after running the function.

### Example Computing Device

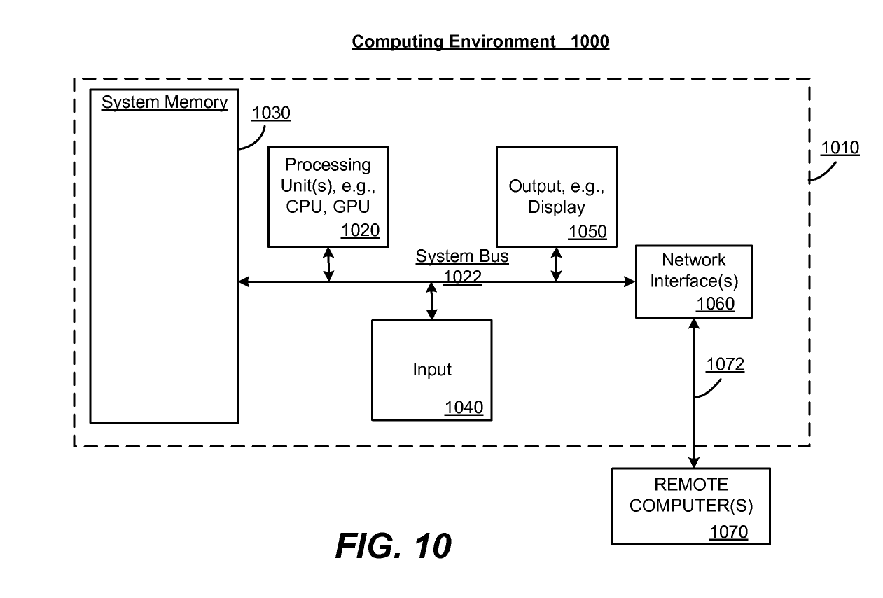

The techniques described herein can be applied to any device or set of devices (machines) capable of running programs and processes. It can be understood, therefore, that personal computers, laptops, handheld, portable and other computing devices and computing objects of all kinds including cell phones, tablet/slate computers, gaming/entertainment consoles and the like are contemplated for use in connection with various implementations including those exemplified herein. Accordingly, the general purpose computing mechanism described below in FIG. 10 is but one example of a computing device.

Implementations can partly be implemented via an operating system, for use by a developer of services for a device or object, and/or included within application software that operates to perform one or more functional aspects of the various implementations described herein. Software may be described in the general context of computer executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is considered limiting.

FIG. 10 thus illustrates an example of a suitable computing system environment 1000 in which one or aspects of the implementations described herein can be implemented, although as made clear above, the computing system environment 1000 is only one example of a suitable computing environment and is not intended to suggest any limitation as to scope of use or functionality. In addition, the computing system environment 1000 is not intended to be interpreted as having any dependency relating to any one or combination of components illustrated in the example computing system environment 1000.

With reference to FIG. 10, an example device for implementing one or more implementations includes a general purpose computing device in the form of a computer 1010. Components of computer 1010 may include, but are not limited to, a processing unit 1020, a system memory 1030, and a system bus 1022 that couples various system components including the system memory to the processing unit 1020.

Computer 1010 typically includes a variety of machine (e.g., computer) readable media and can be any available media that can be accessed by a machine such as the computer 1010. The system memory 1030 may include computer storage media in the form of volatile and/or nonvolatile memory such as read only memory (ROM) and/or random access memory (RAM), and hard drive media, optical storage media, flash media, and so forth; as used herein, machine readable/computer readable storage media stores data that does not include transitory signals, (although other types of machine readable/computer readable media that is not storage media may). By way of example, and not limitation, system memory 1030 may also include an operating system, application programs, other program modules, and program data.

A user can enter commands and information into the computer 1010 through one or more input devices 1040. A monitor or other type of display device is also connected to the system bus 1022 via an interface, such as output interface 1050. In addition to a monitor, computers can also include other peripheral output devices such as speakers and a printer, which may be connected through output interface 1050.

The computer 1010 may operate in a networked or distributed environment using logical connections to one or more other remote computers, such as remote computer 1070. The remote computer 1070 may be a personal computer, a server, a router, a network PC, a peer device or other common network node, or any other remote media consumption or transmission device, and may include any or all of the elements described above relative to the computer 1010. The logical connections depicted in FIG. 10 include a network 1072, such as a local area network (LAN) or a wide area network (WAN), but may also include other networks/buses. Such networking environments are commonplace in homes, offices, enterprise-wide computer networks, intranets and the Internet.

As mentioned above, while example implementations have been described in connection with various computing devices and network architectures, the underlying concepts may be applied to any network system and any computing device or system in which it is desirable to implement such technology.

Also, there are multiple ways to implement the same or similar functionality, e.g., an appropriate API, tool kit, driver code, operating system, control, standalone or downloadable software object, etc., which enables applications and services to take advantage of the techniques provided herein. Thus, implementations herein are contemplated from the standpoint of an API (or other software object), as well as from a software or hardware object that implements one or more implementations as described herein. Thus, various implementations described herein can have aspects that are wholly in hardware, partly in hardware and partly in software, as well as wholly in software.

The word “example” is used herein to mean serving as an example, instance, or illustration. For the avoidance of doubt, the subject matter disclosed herein is not limited by such examples. In addition, any aspect or design described herein as “example” is not necessarily to be construed as preferred or advantageous over other aspects or designs, nor is it meant to preclude equivalent example structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements when employed in a claim.

As mentioned, the various techniques described herein may be implemented in connection with hardware or software or, where appropriate, with a combination of both. As used herein, the terms “component,” “module,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the example systems described herein, methodologies that may be implemented in accordance with the described subject matter can also be appreciated with reference to the flowcharts/flow diagrams of the various figures. While for purposes of simplicity of explanation, the methodologies are shown and described as a series of blocks, it is to be understood and appreciated that the various implementations are not limited by the order of the blocks, as some blocks may occur in different orders and/or concurrently with other blocks from what is depicted and described herein. Where non-sequential, or branched, flow is illustrated via flowcharts/flow diagrams, it can be appreciated that various other branches, flow paths, and orders of the blocks, may be implemented which achieve the same or a similar result. Moreover, some illustrated blocks are optional in implementing the methodologies described herein.

### CONCLUSION

While the invention is susceptible to various modifications and alternative constructions, certain illustrated implementations thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

In addition to the various implementations described herein, it is to be understood that other similar implementations can be used or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be effected across a plurality of devices. Accordingly, the invention is not to be limited to any single implementation, but rather is to be construed in breadth, spirit and scope in accordance with the appended claims.

What is claimed is:

1. A method comprising:
determining whether to wrap an object part with wrapping code including to adding logic related to the object part for execution of the logic during runtime, including making a determination as to whether to wrap based upon wrapping condition data; and
if the determination is to wrap, wrapping the object part with wrapping code to return a wrapped object implementation, or
if the determination is to not wrap, returning an unwrapped object implementation.

2. The method of claim 1 wherein the wrapping condition data indicates that the object part is to be validated during runtime, wherein the determination is to wrap, and wherein wrapping the object part with the wrapping code comprises wrapping the object code with validation wrapping code comprising validation-related logic.

3. The method of claim 2 wherein the object part comprises a function, wherein the wrapping condition data indicates that the function is to be validated during runtime, wherein the determination is to wrap, and wherein wrapping the function with the wrapping code comprises wrapping the object code with validation wrapping code comprising pre-validation logic that executes before invoking the function and post validation logic that executes after invoking the function.

4. The method of claim 3 further comprising, running the pre-validation wrapping code to validate one or more input parameters and running the post-validation code to validate one or more return values of the function.

5. The method of claim 4 wherein running the pre-validation wrapping code results in invoking at least one validation function.

6. The method of claim 1 wherein the wrapping condition data indicates that the object part is to have trace data maintained for the object part when the object part is executed during runtime, wherein the determination is to wrap, and wherein wrapping the object part with the wrapping code comprises wrapping the object code with trace wrapping code.

7. The method of claim 6 further comprising, starting tracing to trace execution of the object part, executing the object part, and stopping tracing.

8. The method of claim 6 further comprising, logging trace information representing a start trace point related to the object part and logging other trace information representing a stop trace point related to the object part.

9. The method of claim 8 wherein logging the trace information representing the start trace point comprises logging a starting time and logging start-related data, and wherein logging other trace information representing a stop trace point comprises logging a stopping time and logging stop-related data.

10. The method of claim 8 wherein the object part comprises a function, wherein logging the trace information representing the start trace point related to the function comprises logging input parameter data to the function, and wherein logging the trace information representing a stop trace point related to the object part comprises logging one or more return values of the function.

11. The method of claim 1 wherein the wrapping condition data indicates that the object part is to be validated and traced during runtime, wherein the determination is to wrap, and wherein wrapping the object part with the wrapping code comprises wrapping the object code with tracing wrapping logic and wrapping the object code with validation wrapping logic.

12. A system comprising:
an object creator that creates an object;
a conditional wrapper, coupled to the object creator, that wraps a part of the object with added logic, the conditional wrapper selectively added to the object by the object creator at object creation time based upon conditional data; and
the conditional wrapper configured to run the added logic before the part of the object is executed during runtime or after the part of the object is executed during runtime, or both before the part of the object is executed during runtime and after the part of the object is executed during runtime.

13. The system of claim 12 wherein the added logic is configured to trigger a validation of data to be used by the part of the object before the part of the object is executed.

14. The system of claim 12 wherein the added logic is configured to trigger a validation of data returned by the part of the object after the part of the object is executed.

15. The system of claim 12 wherein the added logic is configured to trigger a saving of trace-related data with respect to the part of the object before the part of the object is executed and after the part of the object is executed.

16. The system of claim 12 wherein the added logic is configured to trigger a saving of trace-related data generated during execution of the part of the object.

17. The system of claim 12 wherein the added logic is configured to trigger a validation of data corresponding to the part of the object and to trigger a saving of trace-related data corresponding to the part of the object.

18. One or more machine-readable media having machine-executable instructions, which when executed perform steps, comprising:
wrapping a function with pre-validation code and post-validation code, in which the function is selected for wrapping based upon condition data associated with the function at object creation time;
during runtime, running the pre-validation code to determine whether to run the function, and
a) if running the pre-validation code determines that the function is not to run, outputting an error, or
b) if running the pre-validation code determines that the function is to run, running the function, and running post-validation code to determine whether to return a result of the function, and
i) if running the post-validation code determines that the result of the function is not to be returned, outputting an error, or
ii) if running the post-validation code determines that the result of the function is to be returned, returning the result of the function.

19. The one or more machine-readable media of claim 18 having further machine-executable instructions comprising, wrapping the function with trace code based upon the condition data.

20. The one or more machine-readable media of claim 18 wherein wrapping the function with trace code comprises adding logic that saves start trace point data before running the function and that saves stop trace point data after running the function.
